(19) United States
(12) Patent Application Publication
(10) Pub. No.: US 2026/0159039 A1
(43) Pub. Date: Jun. 11, 2026

(54) REINFORCED WIPER BLADE FOR A WINDSCREEN WIPER FRAME

(71) Applicant: VALEO SYSTÈMES D'ESSUYAGE, LE MESNIL SAINT DENIS (FR)

(72) Inventors: Paul Tanguy, Issoire (FR); Patrick Assuid, Issoire (FR)

(73) Assignee: VALEO SYSTÈMES D'ESSUYAGE, LE MESNIL SAINT DENIS (FR)

(21) Appl. No.: 19/126,745

(22) PCT Filed: Nov. 2, 2023
(86) PCT No.: PCT/EP2023/080570

§ 371 Date: May 2, 2025

(30) Foreign Application Priority Data
Nov. 3, 2022 (FR) 2211421

(51) Int. Cl. B60S 1/38; C08K 3/34; C08L 7/00

(52) U.S. Cl. CPC B60S 1/38; C08K 3/34; C08L 7/00; B60S 2001/3829; C08K 2003/343; C08K 2201/005; C08L 2205/06; C08L 2312/00

(57) ABSTRACT

A wiper blade and a windscreen wiper frame having the wiper blade are disclosed herein. At least part of the wiper blade includes a material based on an elastomer and reinforcing fillers. The elastomer has natural rubber and vulcanized ethylene-propylene-diene monomer. The reinforcing fillers include pozzolan.

The invention relates to a wiper blade for a windscreen wiper frame, partly made notably from recycled materials.

Motor vehicles are commonly equipped with windscreen wiper systems to wash and/or wipe the windscreen and prevent the driver's view of his environment from being disturbed. The windscreen wiper frames of such a system are conventionally driven by arms performing an angular to-and-fro movement. These blades rub against the outer surface of the glass, for example the windscreen, and remove the water, taking it out of the driver's field of vision. In a conventional version, the wiper frames are designed as articulated rocking levers that hold the wiper blade at several points. A more recent version, known as a “flat blade”, is in the form of a semi-rigid assembly that holds the wiper blade in place along its entire length.

Generally speaking, a wiper blade is made of an elastically deformable material based on an elastomer supplemented with additives, in particular to improve its mechanical properties, elasticity, resistance to wear and external attack, or to facilitate the implementation of the manufacturing process. Examples include reinforcing fillers, plasticizers, vulcanizing agents and agents for protecting against UV radiation, oxidation, ozone and/or wear. These additives remain necessary to obtain a material with sufficient properties, notably in terms of mechanical strength, sliding properties and without generating excessive noise, to be used in the motor vehicle industry to manufacture wiper blades.

In most cases, both the elastomer and the additives are petrochemical products. However, the growing desire to protect the environment and reduce CO2 emissions is leading toward limiting the use of such petrochemical products.

In the rubber industry, natural rubber can be used as a basic elastomer, with high performance in terms of its elasticity and intrinsic mechanical properties. Natural rubber comes from rubber plantations, making it a biobased material. Combined with biobased plasticizers, the use of natural rubber considerably reduces the proportion of petrochemical materials.

An elastomer blend based on natural rubber, which is notably non-functionalized, and EPDM (ethylene-propylene-diene monomer) can be used.

However, the reinforcing fillers present in additives usually consist of carbon black.

In most elastomer blends for windscreen wipers, the carbon black content is of the order of 25% to 30%.

Carbon black, also known as furnace black or thermal black, is mass-produced by the petrochemical industry via the incomplete combustion of hydrocarbons.

In order to reduce the environmental impact of windscreen wiper manufacture, wiper blades should be made entirely or partly from recycled or biobased materials.

It is also desirable to be able to use these materials in industrial processes, with controlled costs.

However, this material must make it possible to obtain wiper blades with mechanical and physical properties suitable for wiping a motor vehicle window.

Replacing the carbon black in reinforcing fillers is therefore a delicate matter.

Specifically, it is difficult to propose fillers of natural origin, such as silica or kaolin, which are equivalent in terms of reinforcing power.

Similarly, plant-based fillers such as wood or cellulose have limited compatibility with elastomeric polymers, which restricts their use.

Another way of reducing the carbon footprint of wiper blade manufacture is to use recycled materials in the reinforcing fillers.

EP3546302 describes wiper blades for windscreen wiper frames comprising a partly biobased EPDM-based material. It may contain various fillers, such as kaolin.

EP3455107 describes wiper blades including as sole rubber a non-functionalized natural rubber and at least one biobased plasticizer; the material may comprise a biobased reinforcing filler, for example chosen from a mineral filler, wood fibers, cellulose and diatoms.

FR3048216 relates to a wiper blade for a windscreen wiper frame comprising a material which comprises an elastomer and a reinforcing filler which is a kaolin.

Arayapranee W. et al. (J. Appl. Polym. Sci. 2008, 1165-1174) describe blends of natural rubber and EPDM with fillers such as rice husk ash.

Unexpectedly, it has been found in the context of the present invention that ash from industrial processes can be used in rubber formulations to replace all or part of the reinforcing fillers, imparting mechanical properties similar to those of carbon black.

For this reason, one subject of the present invention is a wiper blade for a windscreen wiper frame, at least part of said blade comprising a material based on (i) elastomer containing natural rubber and vulcanized ethylene-propylene-diene monomer (EPDM), and (ii) reinforcing fillers, the reinforcing fillers comprising pozzolan.

A subject of the invention is also the use of pozzolan in the manufacture of a wiper blade for a windscreen wiper frame, said blade comprising an elastomer-based material containing natural rubber and vulcanized ethylene-propylene-diene monomer (EPDM), and at least reinforcing fillers.

Pozzolan is a natural rock consisting of basaltic volcanic slag or slag of similar composition. It has a honeycomb structure.

Pozzolans are generally substances which, in the presence of water, can combine with lime to give very sparingly soluble hydrates.

For the purposes of the invention, the term “pozzolan” refers to silico-aluminous substances such as fly ash from ancillary industrial processes such as those used in cement works. This slag emanating during the process is recovered in the form of hard particle powder, which can be reused as filler.

The pozzolans used according to the invention can, for example, be derived from the combustion of shale coals burnt in thermal power plants and used in the manufacture of cements.

Pozzolans are aluminosilicates. The composition of the elements Al, O and Si can be determined by spectrometry, in particular by scanning microscope coupled to an Xmax 80N silicon energy selection spectrometer. Pozzolans also contain, in smaller amounts, alkali metals or alkaline-earth metals, or transition metals; they notably contain levels of Na, Mg, Fe, Au and calcium. An example of a pozzolan composition that is suitable for use in the invention is shown in FIG. 2.

For the implementation of the invention, the pozzolans preferably used are those which are in the form of amorphous particles; preferably, at least 90% of the pozzolan particles according to the invention are in amorphous form.

Advantageously, the pozzolan particles have a spheroidal shape.

The pozzolan according to the invention is in the form of particles with a mean size of about 4 μm to 5 μm, notably about 4 μm. The mean particle size of the pozzolan particles is preferably less than or equal to 5 μm, i.e. 95% of the population of all the particles has a size less than or equal to 5 μm.

The term “particle size” means the largest dimension of said particle, if it has an irregular shape.

The mean particle size is determined by methods known to those skilled in the art, for instance laser diffraction.

A pozzolan that is particularly suitable for use in the invention is the fly ash having the CAS number 68131-74-8.

Pozzolan in the form of such particles can be used as a reinforcing filler in an elastomer-based material. It imparts a reinforcing nature, compared with a mixture of the same composition but not containing any filler.

Surprisingly, large amounts of pozzolan can be incorporated into rubber and EPDM-based materials, without altering the elastic properties of said material. Specifically, it is known from the prior art in the field of elastomer-based materials that while fillers can stiffen materials, an excessive amount of fillers relative to the elastomer will certainly modify the material's stiffness, but to the detriment of the elasticity. As those skilled in the art know, the amount of filler must be at most equal to the amount of elastomer.

A subject of the invention is thus notably wiper blades for windscreen wiper frames comprising a material having one or more of the features defined in the foregoing, and in which the material contains from 70 to 230 phr of pozzolan.

The amounts expressed in phr (per hundred of rubber) are much higher than the amounts that are acceptable for carbon black.

According to certain embodiments, pozzolan may be present in the material in a proportion of from 100 to 160 phr.

The material composition can thus contain large amounts of fillers, enabling a reduction in the amount of rubber/EPDM and thus in the production costs.

Thus, study of the stress-strain curves shows that a mixture containing 160 phr of pozzolan has a 25% modulus similar to that of a mixture containing 50 phr of carbon black.

According to certain embodiments of the invention, the reinforcing fillers consist entirely of pozzolan.

According to other embodiments, the reinforcing fillers of the material comprise other constituents, and they may notably comprise carbon black.

Pozzolan can constitute from 40% to 100% by mass of the reinforcing fillers, notably from 50% to 100% of the reinforcing fillers, in particular from 50% to 70%.

According to one embodiment, the material also comprises at least one agent chosen from plasticizers, UV stabilizers, antioxidants and vulcanizing agents, notably from plasticizers and antioxidants.

In particular, it comprises at least one plasticizer. A plasticizer is a component which serves to make the material more flexible and/or easier to process for the manufacture of a wiper blade (made of elastomeric material). Generally speaking, plasticizers are often compositions comprising fatty acids, notably mineral or plant oils.

In particular, use will be made of a biobased plasticizer, preferably a biobased oil.

The biobased oil may be chosen from plant oils and/or fats, but also from animal oils and/or fats, or a mixture thereof.

The plant oil and/or fat is notably chosen from sunflower oil, olive oil, rapeseed oil, linseed oil, coconut oil, castor oil, soybean oil and mixtures thereof. The biobased plasticizer may in particular be sunflower oil.

The elastomer contains ethylene-propylene-diene monomer (EPDM), the EPDM being at least partly biobased. EPDM can thus comprise up to 70% biobased ethylene, preferably between 40% and 60%.

For the purposes of the present invention, the term “biobased” refers to a product that is not of fossil origin, but is obtained from renewable resources. Where applicable, it also refers to a biological process. The term “fossil-based” refers to any product derived from petroleum or coal or from petroleum or coal derivatives, notably conventional fuel products derived from petrochemicals.

For example, biobased ethylene can be produced from ethanol obtained from at least one plant material, the plant material notably being chosen from sugar cane, beet, a woody plant or a mixture thereof.

Such blends of natural rubber and EPDM are described in patent application EP3546302.

In particular, use will be made of an elastomer made from a blend of natural rubber and EPDM, half of which is produced from sugarcane ethanol.

The composition may also contain one or more process promoters, notably chemical lubricants such as stearic acid.

The wiper blade material can thus contain up to 75% by weight of biobased and recycled materials, reducing the proportion of petroleum-based ingredients to less than 20% by weight.

According to one embodiment of the invention, the elastomer is vulcanized with peroxide. Such a vulcanization system is notably described in EP3546302; it does not use sulfur, which implies the use of activators or accelerators that may be harmful to the environment. In this embodiment, the wiper blade material does not contain any sulfur. Preferably, the wiper blade material does not contain any zinc oxide either.

Wiper blades for windscreen wiper frames having the features and composition according to the present invention may in particular be obtained by extrusion of the material described in the present patent application.

According to another embodiment, the windscreen wiper blade is obtained by molding the material described above.

A subject of the invention is also a windscreen wiper frame comprising a wiper blade as defined above.

### BRIEF DESCRIPTION OF THE FIGURES

The invention will be better understood on reading the following description given solely by way of example and made with reference to the appended drawings in which:

FIG. 1 shows a wiper blade of a windscreen wiper frame in accordance with the invention.

FIG. 2 shows the elemental composition of a pozzolan determined using a scanning electron microscope coupled to an Xmax 80N silicon energy selection spectrometer (energy 15 kV/40 s acquisition time).

FIG. 3 shows stress-strain curves for material containing pozzolan or carbon black.

FIG. 4 shows stress-strain curves for material with pozzolan contents ranging from 0 to 230 phr.

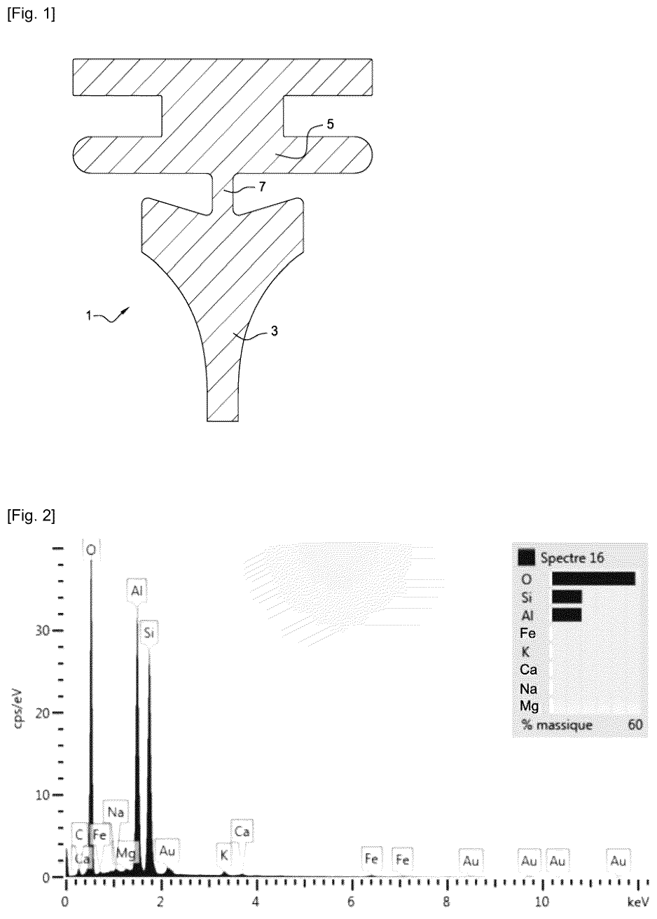

According to FIG. 1, the wiper blade 1 of a windscreen wiper frame in accordance with the invention has an elongated shape and is intended to be carried by a blade body (not shown). The blade 1 comprises a lip 3 and a heel 5 which are connected by a hinge 7. The assembly of lip 3, heel 5 and hinge 7 forms the basic body of the blade 1.

The heel 5 allows the blade 1 to be hooked into the blade body. The lip 3 is designed to be in contact with the outer surface of a window, such as a windscreen, to wipe it.

The hinge 7 is formed by a thin strip of material which gives the blade a certain flexibility and allows it to tilt when the direction of movement of the wiper is changed, in other words, the lip tilts back and forth.

The blade 1 is obtained by a conventional manufacturing process known to those skilled in the art.

Advantageously, at least part of the blade 1 comprises the material as described previously; notably, the base body of the blade comprises this material. It is thus possible to envisage embodiments in which, for example:
only the lip 3 comprises the material,
only the heel 5 comprises the material,
the entire blade 1 comprises the material.

If required, all or part of the surface of the blade 1 can also be treated so as to modify it, for example by graphitization, plasma treatment, halogenation, ion implantation and/or coating. Such a treatment enhances the blade's mechanical, wiping and/or wear-resistance properties.

The wiper blade 1 may thus comprise a monolayer or multilayer coating. The coating covers the base body of the blade 1.

### Example 1: Preparing a Composition

An example of a material formulation used for manufacturing a wiper blade in accordance with the invention is given here for illustrative purposes.

TABLE 1

| Ingredients | phr | % |
|---|---|---|
| PEFC-certified natural rubber | 70 | 32 |
| 50% biobased EPDM | 30 | 14 |
| N550 | 22 | 10 |
| Pyroblack* | 30 | 14 |
| Ultrafine A1 | 30 | 14 |
| Plant oil | 20 | 9 |
| Calcium oxide | 8 | 3.7 |
| Antioxidant | 0.7 | 0.3 |
| Process agent | 3 | 1.4 |
| Peroxide | 2 | 0.9 |

Pyroblack is a recycled black derived from the pyrolysis of recycled used tires.

The formula tested is based on natural rubber+EPDM. Ultrafine A1 is a pozzolan whose composition is shown in FIG. 2, with a mean particle size of 4 microns.

The process agent or process promoter/anti-dispersant agent is a mixture of fatty alcohol, fatty acid and fatty acid ester, such as Aflux® 42 sold by the company Lanxess.

The antioxidant used in this example is 2,2,4-trimethyl-1,2-dihydroquinoline.

The material is prepared using a standard 24D extrusion and salt bath process.

Extrusion produces a smooth K106 profile.

The scorch time (Scorch t5) at 130° C. is 15.4 minutes

The vulcanization kinetics were measured according to the standard ISO3417 RPA Vulcanization Def. 0.5°/Freq. 100 cpm−210° C./10′−T0+1 day
ts2 (min) 0.27
t90 (min) 0.62

The tensile test measurements were performed in accordance with the standard ISO 37 at 500 mm/min.

The elongation of the material subjected to 50% elongation after 72 hours at 85° C. (50% elongation set) was measured in accordance with the standard ISO 2285.

The properties of the material are shown in the table below.

TABLE 2

| | |
|---|---|
| Mooney ML(1 + 4) 100° C. viscosity (pts) | 46 |
| Mooney Scorch t5/130° C. (min) | 15.4 |
| RPA Vulcanization Def. 0.5° / Freq. 100 | |
| S′min (dNm) | 1.41 |
| S′max (dNm) | 14.88 |
| Ts2 (min) | 0.27 |
| T90 (min) | 0.62 |
| BLADE Profile | K106 |
| density | 1.17 |
| 50% Modulus (MPa) | 1.6 |
| 100% Modulus (MPa) | 3.3 |
| Breaking strength (MPa) | 8 |
| Elongation at break (%) | 205 |
| varModulus 50% at 7 d 85° C.(%) | −9 |
| 50% Elongation Set 72 h at 85° C. (%) | 20 |

### Example 2

To evaluate the performance of using ultrafine pozzolan as a reinforcing filler, several rubber compounds were produced with the same formulation, but varying only the type of filler.

The formulations tested were as follows:
Based on natural rubber;
The protection system is composed of diphenylamine amine products and antiozonants;
Conventional sulfur vulcanization with ZnO/stearic acid activators and MBTS/TMTD accelerators

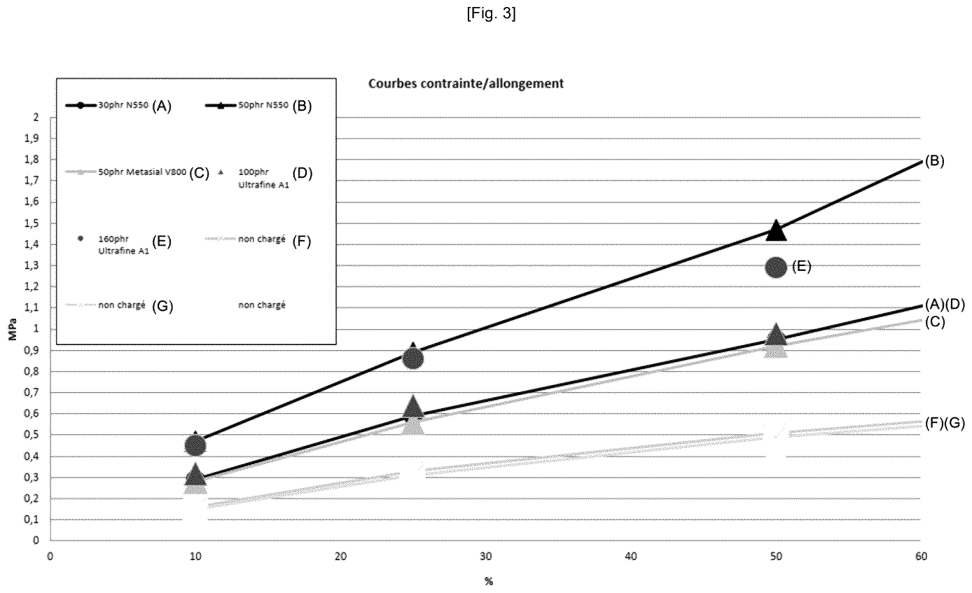

The ultra-fine pozzolan filler has a reinforcing effect compared with an unfilled mixture of the same formulation (NR sulfur vulcanization). The results are shown in FIG. 3.

For example, the 25% Modulus level (which corresponds roughly to the rate of deformation of the hinge of a windscreen wiper blade encountered either statically or in operation) is of the order of 0.6 to 0.9 MPa, compared with just 0.3 MPa in a compound not containing said filler.

The rubber compound is capable of withstanding a high filler content, so that a compound loaded to 160 phr, for example, will have reached the level of a compound containing 50 phr of black in terms of modulus.

### Example 3

The performance of elastomeric materials containing varying levels of pozzolan was measured.

Formula used: based on natural rubber vulcanized with sulfur using a system commonly used in industry: sulfur+2 accelerators

Protection system of the type typically used for windscreen wiper blade formulas. The mixtures are vulcanized under industrial cycle time conditions of 4′/170° C.

The filler contents are shown in the table below. They correspond to percentages of ultrafine pozzolan ranging from 37.8% to 66.8%.

TABLE 3

| | phr | | | | | |
|---|---|---|---|---|---|---|
| Natural Rubber | 100 | 100 | 100 | 100 | 100 | 100 |
| Ultrafine A1 | 0 | 70 | 100 | 130 | 160 | 230 |
| Antioxidant | 1.5 | 1.5 | 1.5 | 1.5 | 1.5 | 1.5 |
| Antiozonant 1 | 2 | 2 | 2 | 2 | 2 | 2 |
| Antiozonant 2 | 2 | 2 | 2 | 2 | 2 | 2 |
| ZnO | 4 | 4 | 4 | 4 | 4 | 4 |
| Stearic acid | 0.8 | 0.8 | 0.8 | 0.8 | 0.8 | 0.8 |
| Sulfur | 0.75 | 0.75 | 0.75 | 0.75 | 0.75 | 0.75 |
| Thiuram accelerator | 1.5 | 1.5 | 1.5 | 1.5 | 1.5 | 1.5 |
| MBTS Accelerator | 2 | 2 | 2 | 2 | 2 | 2 |
| Shore A (pts) | 35 | 51 | 53 | 56 | 60 | 68 |
| Breaking strength (MPa) | 12.9 | 17.3 | 13.2 | 12.5 | 9.9 | 7.5 |

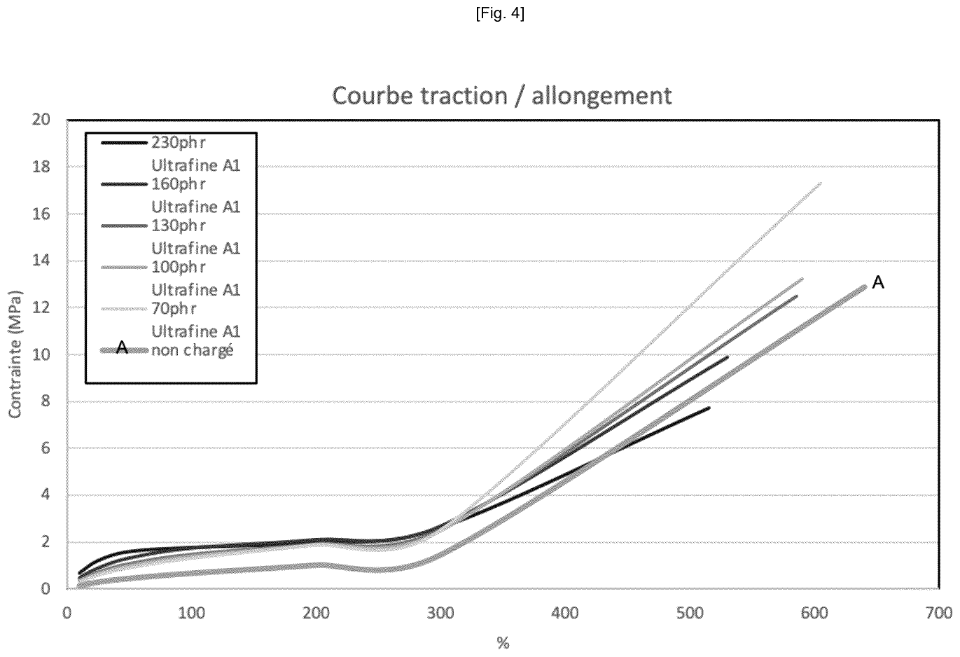

The tensile elongation curves are shown in FIG. 4.

The two antagonistic effects observed on increasing the filler content in a mixture can clearly be seen.

In the 0 to 100% range: this is the increase in stiffness or modulus—the curves in gray and black (max of Ultrafine A1-230 phr) are significantly higher than the curve obtained for the product not containing any filler.

Low modulus measurements can be supplemented by hardness measurements in accordance with the standard NF ISO 48-1, which show that 70 phr is the minimum acceptable to obtain a sufficiently stiff rubber with a Shore A hardness of 51 pts, in order to guarantee leaktightness with respect to water in contact with the windscreen. Below this value, the rubber lip could be crushed, allowing a film of water to pass through when the wiper frame moves.

Between 500%-650%: the range corresponding to the boundary properties of rubber, demonstrates the improvement in breaking strength when the filler content is at 70 phr (17.3 MPa) compared to the unfilled compound (12.9 MPa), but the level of performance trails off with increasing stiffness.

Specifically, the 130 phr compound is much stiffer than the unfilled compound (resp. shore A value of 56 versus 35) and has the same level of breaking strength (12.5 versus 12.9 MPa).

Finally, when this content is exceeded to reach 230 phr, the brittleness limit of the rubber compound at 7.5 MPa is approached. Admittedly, the stiffness increases with the filler content, but this is at the expense of the boundary properties.

1. A wiper blade for a windscreen wiper frame, the wiper blade comprising, at least partially, a material comprising:
elastomer containing natural rubber and vulcanized ethylene-propylene-diene monomer (EPDM); and
reinforcing fillers,
wherein the reinforcing fillers comprise pozzolan.

2. The wiper blade for a windscreen wiper frame as claimed in claim 1, wherein the material contains 70 to 230 phr of pozzolan.

3. The wiper blade for a windscreen wiper frame as claimed in claim 1, wherein the pozzolan is in the form of amorphous particles.

4. The wiper blade for a windscreen wiper frame as claimed in claim 1, wherein the pozzolan is in the form of particles with a mean size of 4 to 5 μm.

5. The wiper blade for a windscreen wiper frame as claimed in claim 1, wherein the reinforcing fillers contain from 50% to 100% by mass of pozzolan.

6. The wiper blade for a windscreen wiper frame as claimed in claim 1, wherein the material also comprises at least one agent chosen from plasticizers and antioxidants.

7. The wiper blade for a windscreen wiper frame as claimed in claim 1, wherein the material contains at least one biobased plasticizer.

8. The wiper blade for a windscreen wiper frame as claimed in claim 1, wherein the elastomer is vulcanized with peroxide.

9. (canceled)

10. The windscreen wiper frame comprising a wiper blade as claimed in claim 1.
